(19) United States
(12) Patent Application Publication
(10) Pub. No.: US 2014/0009341 A1
(43) Pub. Date: Jan. 9, 2014

(54) LOCATION SYSTEM AND CORRESPONDING CALIBRATION METHOD

(71) Applicant: ECOLE POLYTECHNIQUE FEDERAL DE LAUSANNE (EPFL), (US)

(72) Inventors: Cyril Botteron, Le Landeron (CH); Pierre-André Farine, Neuchatel (CH); Phillip Tomé, Cortaillod (CH)

(73) Assignee: ECOLE POLYTECHNIQUE FEDERAL DE LAUSANNE (EPFL), Lausanne (CH)

(21) Appl. No.: 13/771,034

(22) Filed: Feb. 19, 2013

Related U.S. Application Data
(63) Continuation of application No. PCT/EP2011/064117, filed on Aug. 16, 2011.

(30) Foreign Application Priority Data
Aug. 20, 2010 (EP) 10173622.1

(51) Int. Cl. G01S 5/00; G01S 5/02

(52) U.S. Cl. CPC G01S 5/0009; G01S 5/021
USPC 342/463

(57) ABSTRACT

Computerized systems and methods are provided for locating at least one object within a predefined cell or location. In accordance with one implementation, a location system is provided which comprises at least first and second receivers and first and second transmitters, respectively, including first and second internal clocks, the receivers and the transmitters, respectively, having known locations. The location system further includes a transmitter and a receiver, respectively, worn or carried by the object and designed to communicate by signal exchanges with the receivers and the transmitters, respectively. The location system further includes electronic circuits designed to compute position related information of the object based on the signal exchanges.

This application is a continuation of International Application No. PCT/EP2011/064117, filed on Aug. 16, 2011, which claims priority to European (EP) Patent Application No. 10173622.1, filed on Aug. 20, 2010. Each of the above-referenced application is expressly incorporated herein by reference to its entirety.

### TECHNICAL FIELD

The present disclosure generally relates to computerized systems and methods for locating at least one object within a predefined cell or location. More specifically, and without limitation, the exemplary embodiments described herein relate to location systems that may comprise: at least first and second receivers and first and second transmitters, respectively, including first and second internal clocks, the receivers and transmitters having known locations; a transmitter and a receiver, respectively, worn by an object to locate and designed to communicate by means of signal exchanges, of the radio frequency (RF) type, with the receivers and the transmitters; electronic circuits designed to compute a position related information of the object based on the signal exchanges; and at least two reference transmitters and two reference receivers, respectively, arranged to carry out a calibration operation of the first and second internal clocks.

The exemplary embodiments described herein also relate to calibration methods for calibrating receiver and/or transmitter internal clocks in a location system.

### BACKGROUND

Location systems may include, on the one side, long-range location systems, such as GPS, and, on the other hand, short-range systems involving measurements based on radio frequency signalling (e.g., Wi-Fi, ultra wide band signals (UWB), or other technologies (ultrasounds, etc.)).

In both types of systems, accurate knowledge of time is of critical importance in order to enable a precise calculation of signal travelling times between different entities of the systems to compute object positions.

As far as long-range systems are concerned, they typically comprise a constellation of transmitters having known positions and transmitting signals to a receiver whose position is to be assessed. Each transmitter has an internal clock which is synchronized with a master clock the position of which is accurately known. Specific calibration methods are provided in order to avoid time drifting of the transmitter internal clocks.

As far as short-range systems are concerned, they typically aim at locating an object carrying a transmitter within a predefined geometrical cell, eventually indoors. For that purpose, several receivers may be distributed within the cell at precisely known locations. However, the receivers have internal clocks which need to be calibrated and which may be subject to time drifting, which may lead to large errors in the determination of tracked object positions.

Calibration methods for location systems are known, for implementing both frequency and phase synchronizations.

For instance, U.S. Pat. No. 6,882,315 B2 gathers a description of several known location systems and the corresponding calibration methods, with their corresponding drawbacks. In order to improve the exposed drawbacks, this patent proposes an object location system carrying out calculations based on times of arrival (TOA) of signals. The disclosed system comprises receivers located at know positions and synchronized with a common clock source, as well as a reference transmitter also having a known location and arranged to transmit a timing reference signal. This timing reference signal allows a precise determination of TOA of signals transmitted by a tagged object, i.e. an object to be tracked and bearing a transmitter, by determination of the time offset between the receivers.

However, such a solution is heavy in terms of hardware to be installed and in terms of installation complexity. Indeed, the receivers should preferably be connected to the common clock source by means of cables and a great care has to be taken to ensure that the position of the reference transmitter is accurately known, else large errors may result in the measurements.

Another drawback of the above-referenced system resides in the fact that, in case the configuration of the monitored region would have to be changed in a substantial manner, i.e. for instance a receiver would change from a line of sight (LOS) condition to a non line of sight (NLOS) condition with respect to the reference transmitter, the system would have to be re-installed then, with the same requirement of great care.

An alternate solution is presented in WO 2007/122394 A1 in which a calibration data is derived from a location signal based on both time difference of arrival (TDOA) and angle of arrival (AOA) of the location signal. Thus, there is no need to know the position of the transmitter sending the signal from which the calibration data is extracted. However, more antennas are required than in other location systems and the orientation of these antennas is critical in the system installation phase, requiring a great care. Furthermore, the corresponding method implies a large initial statistical computation to determine the offsets of the receiver internal clocks, in order to avoid a propagation of a possible initial calculation error in the later location determinations.

### SUMMARY

Consistent with the present disclosure, systems and methods are provided for locating at least one object within a predefined cell or location. Embodiments consistent with the present disclosure include computer-implemented location systems and methods for calibrating receiver and/or transmitter internal clocks in a location system.

Embodiments of the present disclosure provide accurate location systems requiring few hardware components, as well as less care in installation, with respect to known systems, making these improved location systems particularly flexible and thus well suited for temporary needs, for instance, even in the case of large scale deployable systems.

In accordance with certain embodiments, a location system is provided that comprises a support adapted to link at least two reference transmitters and two reference receivers to each other, the support being configured such that it may be set at least in a first calibration configuration in which the at least two reference transmitters and two reference receivers, respectively, have a relative distance with respect to each other which is, a priori, known for the purpose of carrying out a calibration operation.

In accordance with certain embodiments, the predefined relative distance may advantageously be constant or, alternately, be adjustable.

As known in the art, the time offset of the receivers (or transmitters, in a GPS type system) can be determined on the basis of measurements, the results of which are computed in a system of equations to be solved. Thus, as previously mentioned, a reference transmitter may be used having a known position to change an under-determined system of equations into a determined system of equations to be solved, with the corresponding stated drawbacks. In accordance with certain embodiments of the present disclosure, reference transmitters (or receivers) may be used of unknown positions which, as such, do not help to solve the corresponding system of equations as far as the number of unknowns is increased. However, the fact that the relative distance between the reference transmitters (or receivers) is known allows a decrease of the number of unknowns in the system of equations which may thus become determined under particular conditions.

It is important to note that only the relative distance between the two reference transmitters and the two reference receivers, respectively, needs to be known, i.e., their absolute or relative positions do not need to be a priori known.

According to an alternative embodiment, the two reference transmitters and the two reference receivers, respectively, may have relative positions with respect to each other which are, a priori, known.

For the purpose of defining the relative distance between the two reference transmitters and the two reference receivers, respectively, a support having any suitable form may preferably be provided to link them to each other. The support may be rigid or not, but should present at least a calibration configuration in which the two reference transmitters and the two reference receivers, respectively, are linked to each other so that they have a known relative distance between them.

In accordance with certain embodiments, the support may have at least a second configuration corresponding to a retracted state for the purpose of being transported more easily. Thus, the support may be rigid and have folding or pivoting parts to change from one configuration to another. Alternately, the support may be flexible and include a band or the like, for instance, the length of which is known in its extended state.

Further, in accordance with certain embodiments, the support may be integral with the two reference transmitters and the two reference receivers, respectively, or the latter may be removable from the support.

Apart from the nature of the support and, in addition to the relative distance or relative positions between the two reference transmitters and the two reference receivers, respectively, the orientation (Northing) of the support could be used to get some additional information to solve the system of equations.

In accordance with certain embodiments, the location system may further comprise at least a third receiver and a third transmitter, respectively, and be arranged to enable a location determination of the object in at least two dimensions.

According to a preferred embodiment, the location system may comprise at least four receivers and four transmitters, respectively, to enable a location determination of the object in at least three dimensions, as well as at least a third reference transmitter and a third reference receiver, respectively, having relative distances with respect to the other two reference transmitters and the other two reference receivers, respectively, which are predefined by construction.

In accordance with certain embodiments, the electronic circuits of the location system may be designed so as to carry out a calibration operation by application of an analytical calculation method, for instance based on the method of least squares.

The signals generated in the location system may advantageously be in the ultra wide band (UWB) range.

The present disclosure also relates to embodiments of a calibration method for a location system, for locating at least one object within a predefined cell. The location system may comprise: at least first and second receivers and first and second transmitters, respectively, including first and second internal clocks, the receivers and the transmitters having known locations; a transmitter and a receiver, respectively, worn or carried by the object and designed to communicate by means of signal exchanges with the receivers and the transmitters, respectively; electronic circuits designed to compute a position related information of the object based on the signal exchanges; and at least two reference transmitters and two reference receivers, respectively. Further, the calibration method may comprise the steps of: arranging the reference transmitters and the reference receivers within the cell so that they are linked to each other by a support to have a known predefined relative distance; carrying out signal exchanges between the first and second receivers and each of the reference transmitters, between the first and second transmitters and each of the reference receivers, respectively; programming the electronic circuits so that they compute the signals as received by the first and second receivers, by the reference receivers respectively, by means of an analytical computation method, to carry out a calibration of the first and second internal clocks.

Here again, it is important to note that only the relative distance between the two reference transmitters and the two reference receivers, respectively, needs to be known, i.e., their absolute or relative positions do not need to be a priori known.

In accordance with certain embodiments, when the location system is arranged to carry out three dimension location measurements, the latter comprising at least four receivers and at least four transmitters, respectively, each of which comprises an internal clock, the calibration method may further comprise the steps of: arranging at least a third reference transmitter and at least a third reference receiver, respectively, within the cell and at predefined relative distances with respect to the other two reference transmitters and with respect to the other two reference receivers respectively; carrying out signal exchanges between the receivers and each of the reference transmitters, between the transmitters and each of the reference receivers respectively; and programming the electronic circuits so that they compute the signals as received by the receivers and by the reference receivers, respectively, by means of an analytical computation method, to carry out a calibration of the internal clocks.

Depending on the number of transmitters and receivers, the configuration of the location system may correspond to an under-determined system of equations. In such cases, one or more of the following assumptions may be made when carrying out the above-mentioned programming of the electronic circuits: (i) one of the receiver internal clock and the transmitter internal clock is considered to be a master clock; (ii) at least two of the reference transmitters and the reference receivers are synchronized; and (iii) at least two of the reference transmitters are located within a given known plane such that they have one coordinate in common (e.g. a known height), this coordinate possibly being known.

According to a preferred embodiment, the calibration method according to the present disclosure may be implemented such that the analytical computation to carry out calibration may involve times of arrival (TOA) of signals. However, it may further involve AOA or strength of arrival (SOA) of the signals in order to provide more robustness or use less than four receivers.

Those skilled in the art will appreciate that the conception and features upon which this disclosure is based may readily be utilized as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

The accompanying drawings, which are incorporated in and constitute part of this specification, and together with the description, illustrate and serve to explain the principles of the present disclosure and the exemplary embodiments described herein.

FIG. 1 is a general schematic diagram of an illustrative example of a location system structure, in accordance with embodiments of the present disclosure.

FIG. 2 is a detailed schematic diagram of a known location system according to the prior art.

FIG. 3 is a schematic diagram of a location system corresponding to an exemplary embodiment of the present disclosure.

FIG. 4 is a schematic diagram of a location system according to another exemplary embodiment of the present disclosure.

FIGS. 5a and 5b provide two parts of an equation, to be adjoined to read the complete equation for a location system (such as that of FIG. 4), in accordance with embodiments of the present disclosure.

### DETAILED DESCRIPTION

Reference will now be made in detail to the exemplary embodiments implemented according to the disclosure, the examples of which are illustrated in the accompanying drawings. Wherever possible, the same reference numbers will be used throughout the drawings to refer to the same or like parts.

Embodiments herein include computer-implemented methods, tangible non-transitory computer-readable mediums, and systems. The computer-implemented methods may be executed, for example, by at least one processor that receives instructions from a non-transitory computer-readable storage medium. Similarly, systems consistent with the present disclosure may include at least one processor and memory, and the memory may be a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” may additionally refer to multiple structures, such a plurality of memories and/or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals.

In the following description, the monitoring of an object having a tag will be described, the tag having the function of a transmitter and, as a consequence, receivers are provided in a monitored region to carry out the position determination of the object. However, it should be noted here that location systems consistent with the present disclosure can also be reversed, i.e. the object could carry a receiver while transmitters would be placed at fixed locations, without going beyond the scope of the present disclosure. The same remark applies similarly to calibration methods consistent with the present disclosure.

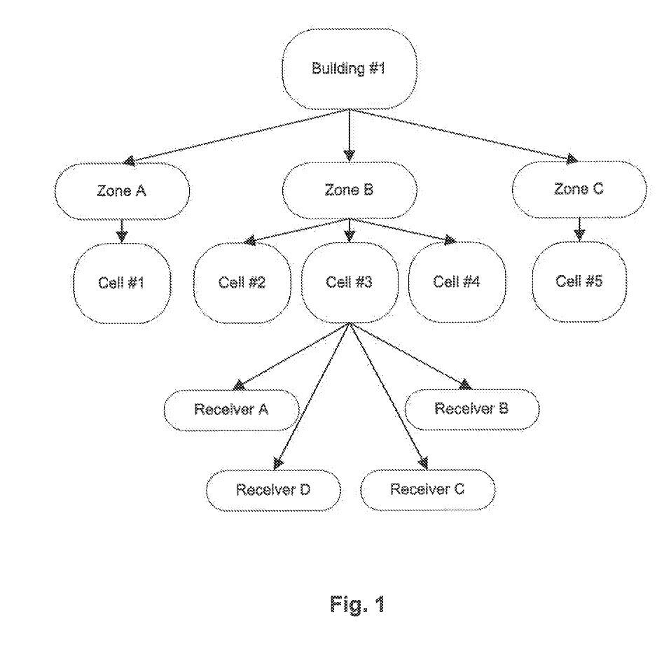

FIG. 1 shows a general schematic diagram of an illustrative example of a location system structure.

The diagram of FIG. 1 illustrates how a hierarchical topology can be defined to describe the installation of a location system.

On the top level, a building is defined which comprises several zones, each of which comprises one or several cells. The location system may comprise several buildings without going beyond the scope of the present disclosure. In alternative, the location system may also be installed outdoors.

Each cell comprises a plurality of receivers arranged to monitor the position of an object carrying a transmitter within the cell. This may be carried by employing conventional techniques known in the art.

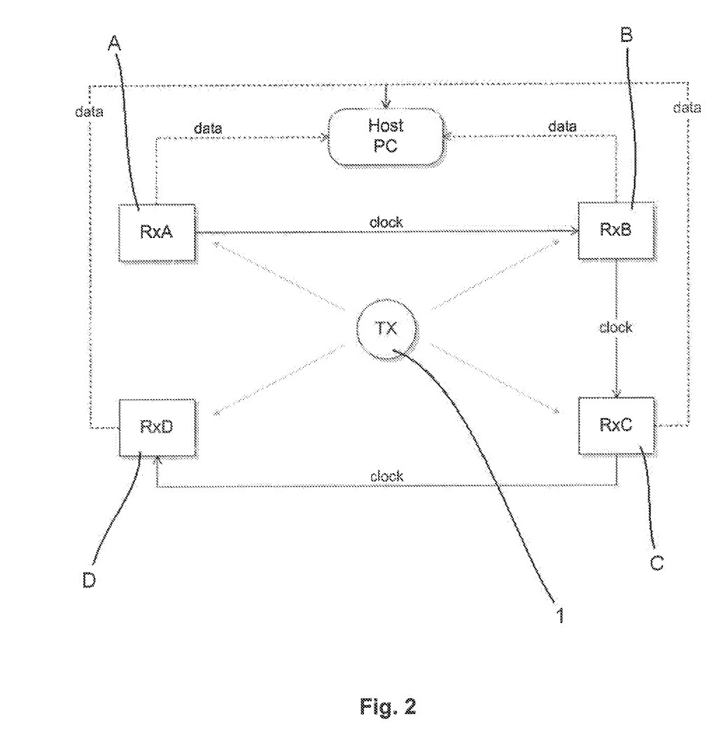

This situation is depicted in more detail on FIG. 2, where four receivers A, B, C and D are provided to monitor the position of an object carrying a transmitter 1.

In the general case, the transmitter is placed arbitrarily within the cell.

Assuming that there is an idealized master clock and that each receiver has its own local internal clock, even though one of these internal clocks may play the role of the master clock, for instance that of the first receiver rxA, distributing its clock to the other receiver clocks rxB, rxC and rxD, the location system may be associated to the following system of equations:

$$\begin{matrix}\{ \begin{matrix}δ {t}^{{rx}_{A}} = \frac{‖ {X}^{{rx}_{A}} - {X}_{{tx}_{1}} ‖}{c} + {t}_{{tx}_{1}} - {\breve{t}}_{{tx}_{1}}^{{rx}_{A}} \\ δ {t}^{{rx}_{B}} = \frac{‖ {X}^{{rx}_{B}} - {X}_{{tx}_{1}} ‖}{c} + {t}_{{tx}_{1}} - {\breve{t}}_{{tx}_{1}}^{{rx}_{B}} \\ δ {t}^{{rx}_{C}} = \frac{‖ {X}^{{rx}_{C}} - {X}_{{tx}_{1}} ‖}{c} + {t}_{{tx}_{1}} - {\breve{t}}_{{tx}_{1}}^{{rx}_{C}} \\ δ {t}^{{rx}_{D}} = \frac{‖ {X}^{{rx}_{D}} - {X}_{{tx}_{1}} ‖}{c} + {t}_{{tx}_{1}} - {\breve{t}}_{{tx}_{1}}^{{rx}_{D}}\end{matrix} & ( Equation 1 )\end{matrix}$$

Where each of δt^{rx}^{_{A}}, δt^{rx}^{_{B}}, δt^{rx}^{_{C}} and δt^{rx}^{_{D}} is the delay between the internal clock of a receiver and the idealized master clock. Indeed, even though receiver A is supplying a master clock to all the other receivers, there are still delays to consider in these receivers caused by the length of the cables carrying the clock signal and due to clock signal buffering/amplification electronics.

Furthermore, X^{rx}^{_{A}}, X^{rx}^{_{B}}, X^{rx}^{_{C}} and X^{rx}^{_{D}} are the known position coordinates of receivers A, B, C and D respectively and \check{t}_{Tx}_{₁}^{Rx}^{_{A}}, \check{t}_{Tx}_{₁}^{Rx}^{_{B}}, \check{t}_{Tx}_{₁}^{Rx}^{_{B}} and \check{t}_{Tx}_{₁}^{Rx}^{_{D}} are the times of arrival (TOA) of the signal emitted by transmitter 1 (tx₁) measured at receivers A, B, C and D respectively using their local clock (hence the symbol \check{} over the t letter).

On the other hand, Xₜₓ_{₁} the unknown absolute position coordinates of transmitter 1 and tₜₓ_{₁} is the unknown signal transmission time expressed on the idealized master clock. C is the constant speed of light to convert from time to distance and vice-versa.

For the system of equations in Equation 1, there are 4 equations for 8 unknowns (δt^{rx}^{_{A}}, δt^{rx}^{_{B}}, δt^{rx}^{_{C}}, δt^{rx}^{_{D}}, tₜₓ_{₁} and Xₜₓ_{₁}=[xₜₓ_{₁} yₜₓ_{₁} zₜₓ_{₁}]^{T}), which makes it clearly an under-determined system (i.e. more unknowns than equations).

Equation 11 can be further simplified if one considers the idealized master clock to be identical to the clock of receiver 1 which is acting as master clock for the remaining slave receivers. With this assumption, Equation 1 gets simplified as follows:

$$\begin{matrix}\{ \begin{matrix}0 = \frac{‖ {X}^{{rx}_{A}} - {X}_{{tx}_{1}} ‖}{c} + {t}_{{tx}_{1}} - {t}_{{tx}_{1}}^{{rx}_{A}} \\ δ {t}^{{rx}_{B}} = \frac{‖ {X}^{{rx}_{B}} - {X}_{{tx}_{1}} ‖}{c} + {t}_{{tx}_{1}} - {\breve{t}}_{{tx}_{1}}^{{rx}_{B}} \\ δ {t}^{{rx}_{C}} = \frac{‖ {X}^{{rx}_{C}} - {X}_{{tx}_{1}} ‖}{c} + {t}_{{tx}_{1}} - {\breve{t}}_{{tx}_{1}}^{{rx}_{C}} \\ δ {t}^{{rx}_{D}} = \frac{‖ {X}^{{rx}_{D}} - {X}_{{tx}_{1}} ‖}{c} + {t}_{{tx}_{1}} - {\breve{t}}_{{tx}_{1}}^{{rx}_{D}}\end{matrix} & ( Equation 2 )\end{matrix}$$

where the time offset δt^{rx}^{_{A}} is now zero. However, the system is still under-determined because there are only 4 equations for 7 unknowns, one less than before because δt^{rx}^{_{A}} has disappeared from the set of equations.

It is worth noting, at this stage, that one conventional solution discussed previously consists of positioning the transmitter at a known absolute position within the cell. Thus, by doing this, the unknowns are decreased from 7 to 4 and the system of equations may be solved. However, this solution presents some drawbacks already discussed and one objective of the present disclosure is to propose an alternate way for the determination of the receiver internal clock offsets.

So now, assume a second transmitter 2 (tx₂) is also placed within the cell limits at an unknown absolute position, but at a known distance from the previous transmitter 1 (tx₁), i.e. the distance between tx₁ and tx₂ is known and equal to dₜₓ_{₁}_{/tx}_{₂}.

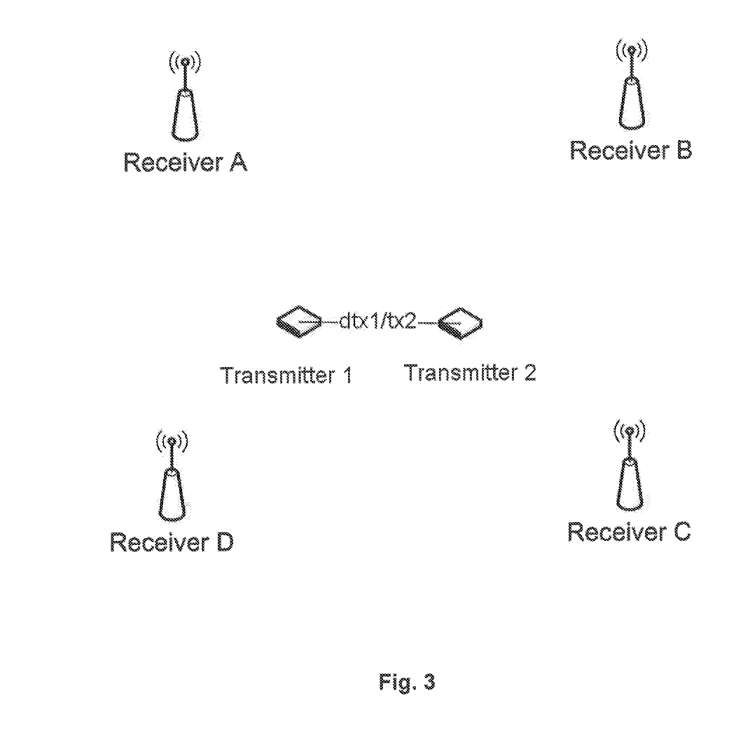

This situation is illustrated on FIG. 3, where transmitters 1 and 2 are located at arbitrary locations within the cell, their relative distance being however predetermined by construction.

The extra set of equations that results from considering the added transmitter is:

$$\{ \begin{matrix}0 = \frac{‖ {X}^{{rx}_{A}} - {X}_{{tx}_{2}} ‖}{c} + {t}_{{tx}_{2}} - {t}_{{tx}_{2}}^{{rx}_{A}} \\ δ {t}^{{rx}_{B}} = \frac{‖ {X}^{{rx}_{B}} - {X}_{{tx}_{2}} ‖}{c} + {t}_{{tx}_{2}} - {\breve{t}}_{{tx}_{2}}^{{rx}_{B}} \\ δ {t}^{{rx}_{C}} = \frac{‖ {X}^{{rx}_{C}} - {X}_{{tx}_{2}} ‖}{c} + {t}_{{tx}_{2}} - {\breve{t}}_{{tx}_{2}}^{{rx}_{C}} \\ δ {t}^{{rx}_{D}} = \frac{‖ {X}^{{rx}_{D}} - {X}_{{tx}_{2}} ‖}{c} + {t}_{{tx}_{2}} - {\breve{t}}_{{tx}_{2}}^{{rx}_{D}} \\ {d}_{{tx}_{1} \text{/} {tx}_{2}} = ‖ {X}_{{tx}_{1}} - {X}_{{tx}_{2}} ‖\end{matrix} \qquad ( Equation 3 )$$

There are now 5 new equations, which added to the previous 4, make a total of 9 equations. However, at the same time, 4 new unknowns have been added, specifically the time of transmission (tₜₓ_{₂}) and the absolute position coordinates (xₜₓ_{₂}=[xₜₓ_{₂} yₜₓ_{₂} zₜₓ_{₂}]^{T}) of transmitter 2, for a total of 11 unknowns. The system is still under-determined.

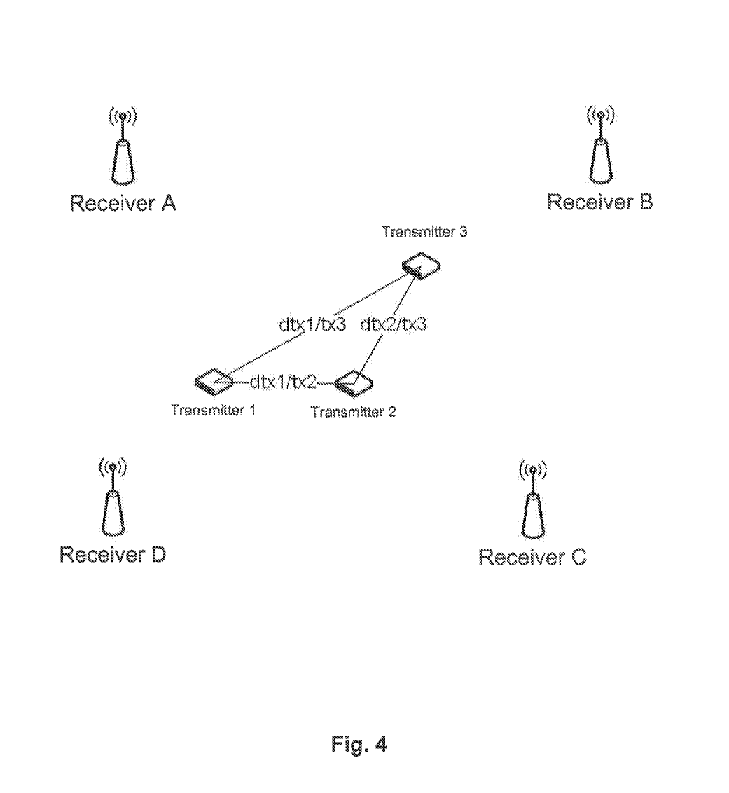

Repeating the procedure of placing another transmitter 3 (tx₃) at a known distance to the previous two other transmitters, i.e. the distance to transmitter 1 is known (dₜₓ_{₁}_{/tx}_{₃}) as well as the distance to transmitter 2 (dₜₓ_{₂}_{/tx}_{₃}), leads to the situation illustrated in FIG. 4.

An extra set of equations can thus be written:

$$\{ \begin{matrix}0 = \frac{‖ {X}^{{rx}_{A}} - {X}_{{tx}_{3}} ‖}{c} + {t}_{{tx}_{3}} - {t}_{{tx}_{3}}^{{rx}_{A}} \\ δ {t}^{{rx}_{B}} = \frac{‖ {X}^{{rx}_{B}} - {X}_{{tx}_{3}} ‖}{c} + {t}_{{tx}_{3}} - {\breve{t}}_{{tx}_{3}}^{{rx}_{B}} \\ δ {t}^{{rx}_{C}} = \frac{‖ {X}^{{rx}_{C}} - {X}_{{tx}_{3}} ‖}{c} + {t}_{{tx}_{3}} - {\breve{t}}_{{tx}_{3}}^{{rx}_{C}} \\ δ {t}^{{rx}_{D}} = \frac{‖ {X}^{{rx}_{D}} - {X}_{{tx}_{3}} ‖}{c} + {t}_{{tx}_{3}} - {\breve{t}}_{{tx}_{3}}^{{rx}_{D}} \\ {d}_{{tx}_{1} / {tx}_{3}} = ‖ {X}_{{tx}_{1}} - {X}_{{tx}_{3}} ‖ \\ {d}_{{tx}_{2} / {tx}_{3}} = ‖ {X}_{{tx}_{2}} - {X}_{{tx}_{3}} ‖\end{matrix} \qquad ( Equation 4 )$$

As in the previous step, by adding an extra transmitter, the same number of 4 unknowns is added to the system, which are the time of transmission of transmitter 3 (tₜₓ_{₃}) and its absolute position coordinates (Xₜₓ_{₃}=[xₜₓ_{₃} yₜₓ_{₃} zₜₓ_{₃}]^{T}). However, due to the position constraints between transmitters, a total of 6 new equations have been added. There is now a total of 15 unknowns and also 15 equations, which is no longer an under-determined system and can be mathematically solved.

So, to summarize Equation 5 presents the full set of non-linear equations and Table 1 the unknowns to be determined, as well as the known inputs.

$$\begin{matrix}\{ \begin{matrix}0 = \frac{‖ {X}^{{rx}_{A}} - {X}_{{tx}_{1}} ‖}{c} + {t}_{{tx}_{1}} - {t}_{{tx}_{1}}^{{rx}_{A}} \\ δ {t}^{{rx}_{B}} = \frac{‖ {X}^{{rx}_{B}} - {X}_{{tx}_{1}} ‖}{c} + {t}_{{tx}_{1}} - {\breve{t}}_{{tx}_{1}}^{{rx}_{B}} \\ δ {t}^{{rx}_{C}} = \frac{‖ {X}^{{rx}_{C}} - {X}_{{tx}_{1}} ‖}{c} + {t}_{{tx}_{1}} - {\breve{t}}_{{tx}_{1}}^{{rx}_{C}} \\ δ {t}^{{rx}_{D}} = \frac{‖ {X}^{{rx}_{D}} - {X}_{{tx}_{1}} ‖}{c} + {t}_{{tx}_{1}} - {\breve{t}}_{{tx}_{1}}^{{rx}_{D}} \\ \begin{matrix}0 = \frac{‖ {X}^{{rx}_{A}} - {X}_{{tx}_{2}} ‖}{c} + {t}_{{tx}_{2}} - {t}_{{tx}_{2}}^{{rx}_{A}} \\ δ {t}^{{rx}_{B}} = \frac{‖ {X}^{{rx}_{B}} - {X}_{{tx}_{2}} ‖}{c} + {t}_{{tx}_{2}} - {\breve{t}}_{{tx}_{2}}^{{rx}_{B}} \\ δ {t}^{{rx}_{C}} = \frac{‖ {X}^{{rx}_{C}} - {X}_{{tx}_{2}} ‖}{c} + {t}_{{tx}_{2}} - {\breve{t}}_{{tx}_{2}}^{{rx}_{C}} \\ δ {t}^{{rx}_{D}} = \frac{‖ {X}^{{rx}_{D}} - {X}_{{tx}_{2}} ‖}{c} + {t}_{{tx}_{2}} - {\breve{t}}_{{tx}_{2}}^{{rx}_{D}} \\ \begin{matrix}0 = \frac{‖ {X}^{{rx}_{A}} - {X}_{{tx}_{2}} ‖}{c} + {t}_{{tx}_{3}} - {t}_{{tx}_{3}}^{{rx}_{A}} \\ δ {t}^{{rx}_{B}} = \frac{‖ {X}^{{rx}_{B}} - {X}_{{tx}_{3}} ‖}{c} + {t}_{{tx}_{3}} - {\breve{t}}_{{tx}_{3}}^{{rx}_{B}} \\ δ {t}^{{rx}_{C}} = \frac{‖ {X}^{{rx}_{C}} - {X}_{{tx}_{3}} ‖}{c} + {t}_{{tx}_{3}} - {\breve{t}}_{{tx}_{3}}^{{rx}_{C}} \\ δ {t}^{{rx}_{D}} = \frac{‖ {X}^{{rx}_{D}} - {X}_{{tx}_{3}} ‖}{c} + {t}_{{tx}_{3}} - {\breve{t}}_{{tx}_{3}}^{{rx}_{D}} \\ {d}_{{tx}_{1} / {tx}_{2}} = ‖ {X}_{{tx}_{1}} - {X}_{{tx}_{2}} ‖ \\ {d}_{{tx}_{1} / {tx}_{3}} = ‖ {X}_{{tx}_{1}} - {X}_{{tx}_{3}} ‖ \\ {d}_{{tx}_{2} / {tx}_{3}} = ‖ {X}_{{tx}_{2}} - {X}_{{tx}_{3}} ‖\end{matrix}\end{matrix}\end{matrix} & ( Equation 5 )\end{matrix}$$

Table 1 follows:

| | | |
|---|---|---|
| Unknowns | δt^{rx}^{_{B}} | Clock offset of receiver B |
| | δt^{rx}^{_{C}} | Clock offset of receiver C |
| | δt^{rx}^{_{D}} | Clock offset of receiver D |
| | Xₜₓ_{₁} = [xₜₓ_{₁} yₜₓ_{₁} zₜₓ_{₁}]^{T} | Transmitter 1 absolute position |
| | | coordinates |
| | Xₜₓ_{₂} = [xₜₓ_{₂} yₜₓ_{₂} zₜₓ_{₂}]^{T} | Transmitter 2 absolute position |
| | | coordinates |
| | Xₜₓ_{₃} = [xₜₓ_{₃} yₜₓ_{₃} zₜₓ_{₃}]^{T} | Transmitter 3 absolute position |
| | | coordinates |
| | tₜₓ_{₁} | Transmitter 1 signal transmission time |
| | tₜₓ_{₂} | Transmitter 2 signal transmission time |
| | tₜₓ_{₃} | Transmitter 3 signal transmission time |
| Measure- | \check{t}ₜₓ_{₁}^{rx}^{_{A}} | Measured reception time at receiver |
| ments/ | | A of signal transmitted by transmitter 1 |
| Known | \check{t}ₜₓ_{₁}^{rx}^{_{B}} | Measured reception time at receiver |
| parameters | | B of signal transmitted by transmitter 1 |
| | \check{t}ₜₓ_{₁}^{rx}^{_{C}} | Measured reception time at receiver |
| | | C of signal transmitted by transmitter 1 |
| | \check{t}ₜₓ_{₁}^{rx}^{_{D}} | Measured reception time at receiver |
| | | D of signal transmitted by transmitter 1 |
| | \check{t}ₜₓ_{₂}^{rx}^{_{A}} | Measured reception time at receiver |
| | | A of signal transmitted by transmitter 2 |
| | \check{t}ₜₓ_{₂}^{rx}^{_{B}} | Measured reception time at receiver |
| | | B of signal transmitted by transmitter 2 |
| | \check{t}ₜₓ_{₂}^{rx}^{_{C}} | Measured reception time at receiver |
| | | C of signal transmitted by transmitter 2 |
| | \check{t}ₜₓ_{₂}^{rx}^{_{D}} | Measured reception time at receiver |
| | | D of signal transmitted by transmitter 2 |
| | \check{t}ₜₓ_{₃}^{rx}^{_{A}} | Measured reception time at receiver |
| | | A of signal transmitted by transmitter 3 |
| | \check{t}ₜₓ_{₃}^{rx}^{_{B}} | Measured reception time at receiver |
| | | B of signal transmitted by transmitter 3 |
| | \check{t}ₜₓ_{₃}^{rx}^{_{C}} | Measured reception time at receiver |
| | | C of signal transmitted by transmitter 3 |
| | \check{t}ₜₓ_{₃}^{rx}^{_{D}} | Measured reception time at receiver |
| | | D of signal transmitted by transmitter 3 |
| | X^{rx}^{_{A}} = [x^{rx}^{_{A}} y^{rx}^{_{A}} z^{rx}^{_{A}}]^{T} | Receiver A absolute position |
| | | coordinates |
| | X^{rx}^{_{B}} = [x^{rx}^{_{B}} y^{rx}^{_{B}} z^{rx}^{_{B}}]^{T} | Receiver B absolute position |
| | | coordinates |
| | X^{rx}^{_{C}} = [x^{rx}^{_{C}} y^{rx}^{_{C}} z^{rx}^{_{C}}]^{T} | Receiver C absolute position |
| | | coordinates |
| | X^{rx}^{_{D}} = [x^{rx}^{_{D}} y^{rx}^{_{D}} z^{rx}^{_{D}}]^{T} | Receiver D absolute position |
| | | coordinates |
| | dₜₓ_{₁}_{/tx}_{₂} | Known distance between transmitters 1 |
| | | and 2 |
| | dₜₓ_{₁}_{/tx}_{₃} | Known distance between transmitters 1 |
| | | and 3 |
| | dₜₓ_{₂}_{/tx}_{₃} | Known distance between transmitters 2 |
| | | and 3 |
| | C | Speed of light |

Through the method of least squares (LSQ), for instance, this system of non-linear equations can be solved as more measurements are received (i.e. by extending the calibration procedure to several minutes) to improve the estimation of the unknowns.

However, to use LSQ, the equations need to be first linearized around a first guess of the solution. The LSQ then estimates the adjustments to be introduced to this solution until it minimizes the sum of the squared difference between the measurements and predicted measurements using the estimated solution.

The first estimate for the clock offsets of receivers B, C and D can be zero. The first estimate for the position of transmitter 1 can be the center of the cell. For the remaining transmitters, a first estimate of their positions can be made by respecting the known relative distances between them. Finally, the first estimate for the time of transmission for each transmitter can be obtained from the measured time of reception at a certain receiver minus the time of flight of the signal, considering the direct geometric distance between the receivers and the assumed positions of the transmitters.

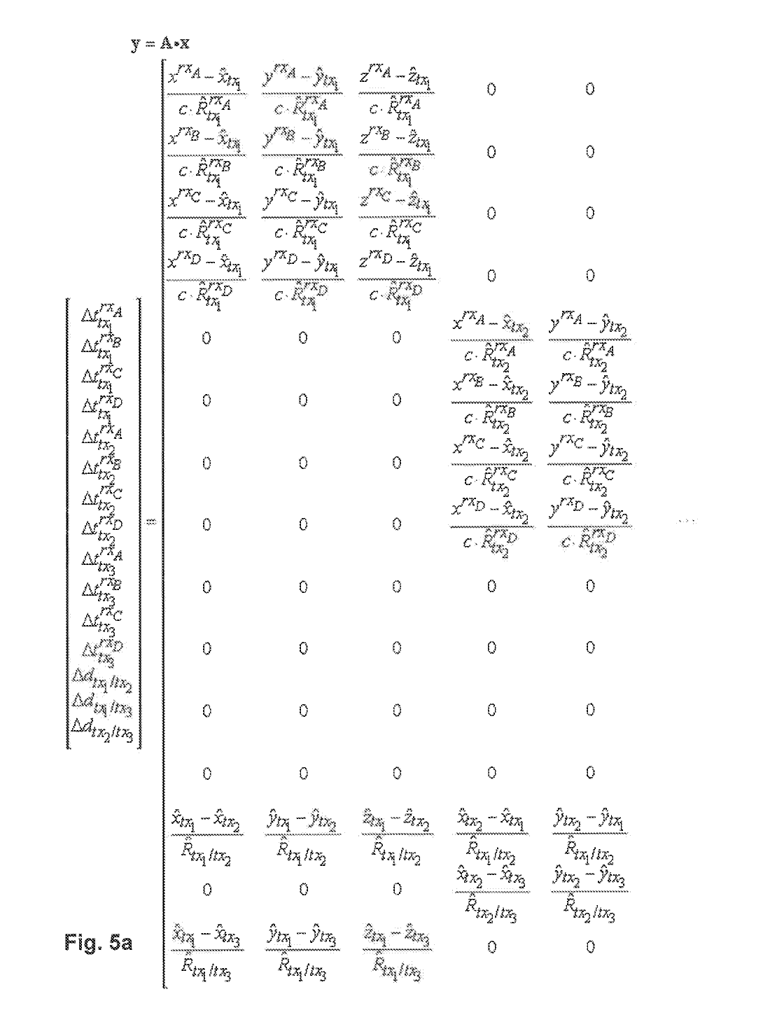

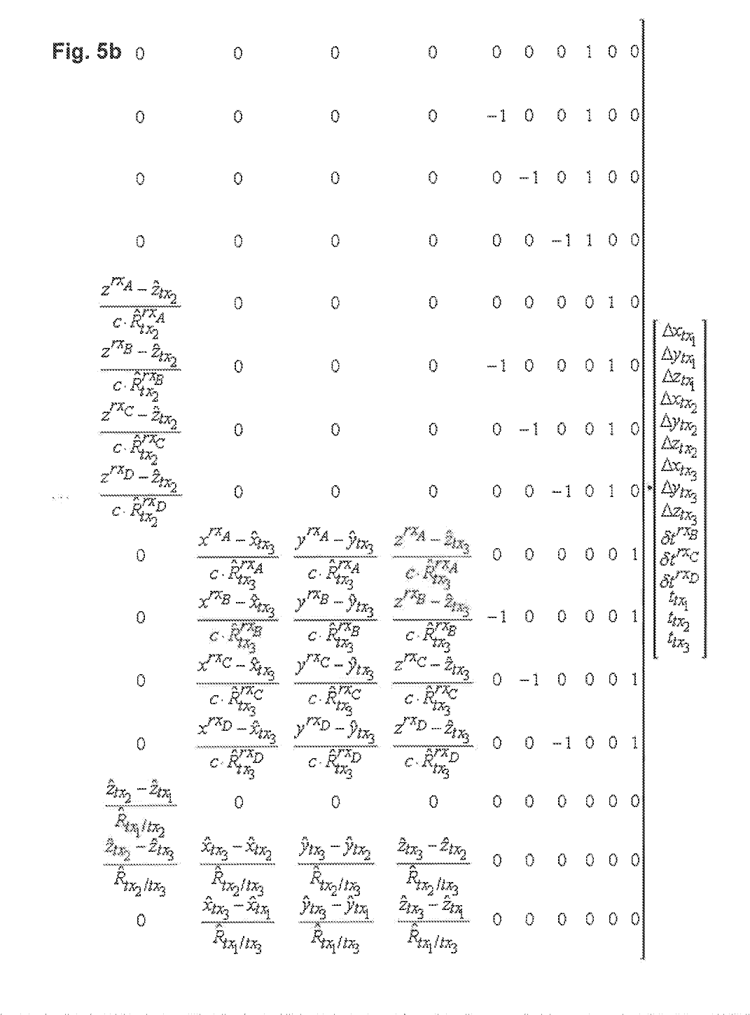

FIGS. 5a and 5b, to be read once they are adjoined, depict the linearized set of equation in matrix format, where

Rₐ^{b}=R_{ab}=\sqrt{(xₐ−x_{b})²+(yₐ−y_{b})²+(zₐ−z_{b})²}.

The procedure then may go on as follows:

For each new TOA measurement received, Δtₜₓ_{_{?}}^{rx}^{_{?}}; are computed from the difference between the new TOA measurements (\check{t}ₜₓ_{_{?}}^{rx}^{_{?}}) and its prediction

$${\hat{t}}_{{tx}_{?}}^{{rx}_{?}} = \frac{‖ {X}^{{rx}_{?}} - {\hat{X}}_{{tx}_{?}} ‖}{c} + {\hat{t}}_{{tx}_{?}} - \hat{δ} {t}^{{rx}_{?}} ) .$$

That is Δtₜₓ_{_{?}}^{rx}^{_{?}}=\check{t}ₜₓ_{_{?}}^{rx}^{_{?}}−\check{t}ₜₓ_{_{?}}^{rx}^{_{?}}.

Similarly, Δdₜₓ_{_{ε}}ₜₓ_{_{?=d}}ₜₓ_{_{?}}_{/tx}_{₂}−\hat{d}ₜₓ_{_{?}}_{/tx}_{_{?}}, where

\hat{d}ₜₓ_{_{?}}_{/tx}_{_{?}}=∥\hat{X}ₜₓ_{_{?}}−\hat{X}ₜₓ_{_{?}}∥.

After applying the LSQ formula, the new position estimates for transmitters 1, 2 and 3 at iteration K are obtained as \hat{x}ₜₓ_{_{?K}}=[\hat{x}ₜₓ_{_{?K}} ŷₜₓ_{_{?K}} \hat{z}ₜₓ_{_{?K}}]^{T}=\hat{X}ₜₓ_{_{?K-1}}+Δ\hat{X}ₜₓ_{_{?K}}, while the receivers' clock offsets \hat{δ}t^{rx}^{_{?}} and transmission times \hat{t}ₜₓ_{_{?}} are obtained directly.

Then, the LSQ iteration finishes when there are no TOA measurements or when a certain stopping criterion is reached.

It appears from these explanations that the transmitters having known relative positions between each other play the role of reference transmitters for the purpose of calibrating the location system.

Further, it is worthy to note here that the explanations which precede relate to an exemplary embodiment and that the scope of the present disclosure is not limited to this specific case.

Indeed, these explanations relate to the case where 3D location is to be carried out. However, if a person of ordinary skill in the art needs only to carry out a 2D location of objects, for instance, the situation of FIG. 3 would fulfil the required conditions to calibrate the internal clocks of the four receivers A, B, C and D. Indeed, in the case of 2D location, the unknowns are decreased by one per transmitter (its z coordinate) and thus, with the location system comprising four receivers and two transmitters, we have 9 unknowns for 9 equations, corresponding to a determined system of equations.

More generally, based on the present disclosure, a person of ordinary skill in the art may consider the following explanations to determine what location system configuration may suit his/her needs.

Considering first a 2D location system with M receivers and N reference transmitters (M and N being equal to or greater than one) within a predefined cell, the following initial assumptions may be used:
The position of all receivers is known
The positions of transmitters are not known.

Before deriving the time of flight (TOF) equation for the M receivers and N transmitters it would be more intuitive to start with the case of one transmitter and one receiver.

The equation for TOF for one receiver and one transmitter is:

$${TOF}_{r} = ( {t}_{r}^{′} - δ {t}_{r} ) - {t}_{t} = \frac{1}{c} ‖ {\vec{X}}_{r} - \vec{x} ‖$$

where tᵣ′ the time of arrival which is measured by using receiver's local clock and is independent of time of transmission, δtᵣ is clock offset of receiver, tₜ is a time of transmission of the signal, C is propagation speed of the signal, \vec{X}ᵣ is position co-ordinate of the receiver in 2-Dimensional plane which is known, and \vec{x} is position co-ordinate of transmitter in 2-Dimensional plane which is unknown.

From this equation, it may be observed that in the case of one receiver and one transmitter there are four unknowns: (1) clock offset, (2) time of transmission, and (3)-(4) coordinate of transmitter (x, y).

Now we consider a two receivers and one transmitter case which gives one more equation for TOF while the number of unknowns will increase by one due to clock offset of the newly added receiver such that the total number of unknowns is five.

If one more transmitter is added, while keeping unchanged the number of receivers, there will be four TOF equations and we add three unknowns (x and y co-ordinates for transmitter and time of transmission).

By generalizing this condition, it can be seen that for M receivers and N transmitters there are MN equations and M unknowns for the clock-offset of each receiver, N unknowns for the times of transmission and 2N unknowns for the positions of the transmitters.

The number of equations is thus MN, while the number of unknowns is M+3N.

To be able to solve these equations, there must be a number of equations equal or greater to the number of unknowns which imply that MN>=M+3N.

By considering the cases up to ten receivers and ten transmitters, the difference between the number of equations and the number of unknowns behaves as shown in the following table:

| MN − | | M (number of receivers) | | | | | | | | | |
|---|---|---|---|---|---|---|---|---|---|---|---|
| (M + 3N) | | 1 | 2 | 3 | 4 | 5 | 6 | 7 | 8 | 9 | 10 |
| N (Number of | 1 | −3 | −3 | −3 | −3 | −3 | −3 | −3 | −3 | −3 | −3 |
| transmitters) | 2 | −5 | −4 | −3 | −2 | −1 | 0 | 1 | 2 | 3 | 4 |
| | 3 | −7 | −5 | −3 | −1 | 1 | 3 | 5 | 7 | 9 | 11 |
| | 4 | −9 | −6 | −3 | 0 | 3 | 6 | 9 | 12 | 15 | 18 |
| | 5 | −11 | −7 | −3 | 1 | 5 | 9 | 13 | 17 | 21 | 25 |
| | 6 | −13 | −8 | −3 | 2 | 7 | 12 | 17 | 22 | 27 | 32 |
| | 7 | −15 | −9 | −3 | 3 | 9 | 15 | 21 | 27 | 33 | 39 |
| | 8 | −17 | −10 | −3 | 4 | 11 | 18 | 25 | 32 | 39 | 46 |
| | 9 | −19 | −11 | −3 | 5 | 13 | 21 | 29 | 37 | 45 | 53 |
| | 10 | −21 | −12 | −3 | 6 | 15 | 24 | 33 | 42 | 51 | 60 |

In the above table, negative numbers show that the number of unknowns is higher than number of equations. When the number of equations is one less than the number of unknowns, they can be solved by considering one clock of the receiver as master clock, for instance.

It is possible to find the receiver clock offsets (without any particular assumption) for the following location system configuration: 2 transmitters and at least 6 receivers, 3 transmitters and at least 5 receivers and 4 or more transmitters associated with 4 or ore receivers.

Going further, we can consider that one of the receiver internal clock is master clock for all other receiver internal clocks.

This implies a decrease of the number of unknowns by 1 and the new condition to fulfil to have a determined system of equations is: MN>=M+3N−1.

By considering the cases up to ten receivers and ten transmitters, the difference between the number of equations and the number of unknowns behaves as shown in the amended following table:

| MN − | | M (number of receivers) | | | | | | | | | |
|---|---|---|---|---|---|---|---|---|---|---|---|
| (M + 3N − 1) | | 1 | 2 | 3 | 4 | 5 | 6 | 7 | 8 | 9 | 10 |
| N (Number of | 1 | −2 | −2 | −2 | −2 | −2 | −2 | −2 | −2 | −2 | −2 |
| transmitters) | 2 | −4 | −3 | −2 | −1 | 0 | 1 | 2 | 3 | 4 | 5 |
| | 3 | −6 | −4 | −2 | 0 | 2 | 4 | 6 | 8 | 10 | 12 |
| | 4 | −8 | −5 | −2 | 1 | 4 | 7 | 10 | 13 | 16 | 19 |
| | 5 | −10 | −6 | −2 | 2 | 6 | 10 | 14 | 18 | 22 | 26 |
| | 6 | −12 | −7 | −2 | 3 | 8 | 13 | 18 | 23 | 28 | 33 |
| | 7 | −14 | −8 | −2 | 4 | 10 | 16 | 22 | 28 | 34 | 40 |
| | 8 | −16 | −9 | −2 | 5 | 12 | 19 | 26 | 33 | 40 | 47 |
| | 9 | −18 | −10 | −2 | 6 | 14 | 22 | 30 | 38 | 46 | 54 |
| | 10 | −20 | −11 | −2 | 7 | 16 | 25 | 34 | 43 | 52 | 61 |

It appears from this table that a minimum of 3 transmitters combined with 4 receivers leads to a determined set of equations.

Going still further, a second case scenario may be considered where there are N transmitters and where the position of each transmitter is known with respect to first transmitter. In other words, the relative positions of all N−1 transmitters is known with respect to first transmitter.

In such a case, the number of unknowns is N+M+2, while the number of equations is still NM.

By considering the cases up to ten receivers and ten transmitters, the difference between the number of equations and the number of unknowns behaves as shown in the amended following table:

| MN − | | M (number of receivers) | | | | | | | | | |
|---|---|---|---|---|---|---|---|---|---|---|---|
| (M + N + 2) | | 1 | 2 | 3 | 4 | 5 | 6 | 7 | 8 | 9 | 10 |
| N (Number of | 1 | −3 | −3 | −3 | −3 | −3 | −3 | −3 | −3 | −3 | −3 |
| transmitters) | 2 | −3 | −2 | −1 | 0 | 1 | 2 | 3 | 4 | 5 | 6 |
| | 3 | −3 | −1 | 1 | 3 | 5 | 7 | 9 | 11 | 13 | 15 |
| | 4 | −3 | 0 | 3 | 6 | 9 | 12 | 15 | 18 | 21 | 24 |
| | 5 | −3 | 1 | 5 | 9 | 13 | 17 | 21 | 25 | 29 | 33 |
| | 6 | −3 | 2 | 7 | 12 | 17 | 22 | 27 | 32 | 37 | 42 |
| | 7 | −3 | 3 | 9 | 15 | 21 | 27 | 33 | 39 | 45 | 51 |
| | 8 | −3 | 4 | 11 | 18 | 25 | 32 | 39 | 46 | 53 | 60 |
| | 9 | −3 | 5 | 13 | 21 | 29 | 37 | 45 | 53 | 61 | 69 |
| | 10 | −3 | 6 | 15 | 24 | 33 | 42 | 51 | 60 | 69 | 78 |

It appears from this table that a minimum of 3 transmitters combined with 3 receivers leads to a determined set of equations.

Another assumption that can be made or condition that can be carried out in the location system is that the time interval between the time of transmission of each transmitter with respect to that of a first transmitter is known. For instance, if first transmitter transmits at t0 then second transmitter will transmit at t0+t1, third transmitter at t0+t2 . . . etc where t1, t2, t3 are known. Here, only the time of transmission of the first transmitter will be unknown which decreases the total number of unknowns by N−1.

In such a case, the number of unknowns is M+2N+1, while the number of equations is still NM.

By considering the cases up to ten receivers and ten transmitters, the difference between the number of equations and the number of unknowns behaves as shown in the amended following table:

| MN − | | M (number of receivers) | | | | | | | | | |
|---|---|---|---|---|---|---|---|---|---|---|---|
| (M + 2N + 1) | | 1 | 2 | 3 | 4 | 5 | 6 | 7 | 8 | 9 | 10 |
| N (Number of | 1 | −3 | −3 | −3 | −3 | −3 | −3 | −3 | −3 | −3 | −3 |
| transmitters) | 2 | −4 | −3 | −2 | −1 | 0 | 1 | 2 | 3 | 4 | 5 |
| | 3 | −5 | −3 | −1 | 1 | 3 | 5 | 7 | 9 | 11 | 13 |
| | 4 | −6 | −3 | 0 | 3 | 6 | 9 | 12 | 15 | 18 | 21 |
| | 5 | −7 | −3 | 1 | 5 | 9 | 13 | 17 | 21 | 25 | 29 |
| | 6 | −8 | −3 | 2 | 7 | 12 | 17 | 22 | 27 | 32 | 37 |
| | 7 | −9 | −3 | 3 | 9 | 15 | 21 | 27 | 33 | 39 | 45 |
| | 8 | −10 | −3 | 4 | 11 | 18 | 25 | 32 | 39 | 46 | 53 |
| | 9 | −11 | −3 | 5 | 13 | 21 | 29 | 37 | 45 | 53 | 61 |
| | 10 | −12 | −3 | 6 | 15 | 24 | 33 | 42 | 51 | 60 | 69 |

It appears from this table that, in this case also, a minimum of 3 transmitters combined with 4 receivers leads to a determined set of equations.

If considering now a three dimension case, the entire location system is placed in a three dimensional co-ordinate system. This scenario is an extension of the preceding two dimensional case by introducing the third co-ordinate for the receivers and transmitters which in turn adds one more unknown (the z co-ordinate) for each transmitter (the positions of receivers being already known).

In such a situation, the number of unknowns is M+4N, while the number of equations is still NM.

By considering again the cases up to ten receivers and ten transmitters, the difference between the number of equations and the number of unknowns behaves as shown in the amended following table:

| MN − | | M (number of receivers) | | | | | | | | | |
|---|---|---|---|---|---|---|---|---|---|---|---|
| (M + 2N + 1) | | 1 | 2 | 3 | 4 | 5 | 6 | 7 | 8 | 9 | 10 |
| N (Number | 1 | −4 | −4 | −4 | −4 | −4 | −4 | −4 | −4 | −4 | −4 |
| of | 2 | −7 | −6 | −5 | −4 | −3 | −2 | −1 | 0 | 1 | 2 |
| transmitters) | 3 | −10 | −8 | −6 | −4 | −2 | 0 | 2 | 4 | 6 | 8 |
| | 4 | −13 | −10 | −7 | −4 | −1 | 2 | 5 | 8 | 11 | 14 |
| | 5 | −16 | −12 | −8 | −4 | 0 | 4 | 8 | 12 | 16 | 20 |
| | 6 | −19 | −14 | −9 | −4 | 1 | 6 | 11 | 16 | 21 | 26 |
| | 7 | −22 | −16 | −10 | −4 | 2 | 8 | 14 | 20 | 26 | 32 |
| | 8 | −25 | −18 | −11 | −4 | 3 | 10 | 17 | 24 | 31 | 38 |
| | 9 | −28 | −20 | −12 | −4 | 4 | 12 | 20 | 28 | 36 | 44 |
| | 10 | −31 | −22 | −13 | −4 | 5 | 14 | 23 | 32 | 41 | 50 |

It appears from this table that a minimum of 3 transmitters combined with 6 receivers leads to a determined set of equations.

In accordance with the present disclosure, a system of 3 transmitters combined with 4 receivers could be solved provided that one receiver internal clock is considered as a master clock and all relative distances between transmitters are known. Based on the latter explanations regarding the different possible configurations, in particular in the 3D case, it can be deduced that 3 transmitters combined with 3 receivers would lead to a determined system if the relative position—in the location system reference frame—of each transmitter is known with respect to one arbitrarily chosen transmitter (the absolute position of which being unknown). Such a solution would thus require less hardware but would imply more care in the installation stage regarding the absolute orientation of the set of transmitters.

However, if the relative positions of the transmitters with respect to each other are known in the transmitter local reference frame, their relative distances can be deduced and we have again the situation depicted by Equation 5, without the requirement of special care in the installation stage.

The above description corresponds to embodiments of the present disclosure described by way of non-limiting examples. In particular, the given exemplary numbers of transmitters and receivers are non-limiting.

Further and by way of example, a person of ordinary skill in the art will encounter no particular problem in building a set of transmitters (or receivers in the reversed case scenario) such that their relative distances or positions are known, according to his/her specific needs, without departing from the scope of the present disclosure. Indeed, one could provide any kind of support designed so as to receive a plurality of transmitters at known relative distances with respect to each other. Preferably, such a support should be portable so as to allow an easy transportation.

For the purpose of defining the relative distance between the reference transmitters, the reference receivers respectively, a support having any suitable form may preferably be provided to link them to each other. Thus, this support may be rigid or not but should present at least a calibration configuration in which the reference transmitters, the reference receivers respectively, are linked to each other so that they have a known relative distance between them.

Possibly, the support may have at least a second configuration corresponding to a retracted state for the purpose of being transported more easily. Thus, the support may be rigid and have folding or pivoting parts to change from one configuration to another. Alternately, the support may be flexible and include a band or the like, for instance, the length of which is known in its extended state.

Further, the support may be integral with the reference transmitters, the reference receivers respectively, or the latter may be removable from the support without going beyond the scope of the present invention. Based on the present disclosure, a person of ordinary skill in the art may use any suitable attaching element to attach the support to the reference transmitters, the reference receivers respectively, according to his specific needs. The support may be removed or not from the reference transmitters, the reference receivers respectively, once the calibration operation has been carried out.

As previously noted, only the relative distance between the reference transmitters, the reference receivers respectively, needs to be known, i.e., their absolute or relative positions do not need to be a priori known. In addition to the relative distance or relative positions between the reference transmitters, the reference receivers respectively, the orientation (Northing) of the support could be used to get some additional information to solve the system of equations.

On the one hand, location systems and calibration methods consistent with the present disclosure, may advantageously suit any number of temporary needs, e.g., to monitor the positions of objects or persons in a temporary fair or exhibition. In such cases, the principle of self-calibration according to the present disclosure could be easily repeated, for instance, each time the configuration of the cell would be changed (such like walls which could be displaced within the cell, changing the state of at least one transmitter from LOS to NLOS). On the other hand, the calibration transmitter set could remain in place on a permanent basis in order to perform a periodic calibration and avoid any drifting of the clocks over time, without going beyond the scope of the present disclosure.

In the preceding paragraphs, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, advantageous results still could be achieved if steps of the disclosed techniques were performed in a different order and/or if components in the disclosed systems were combined in a different manner and/or replaced or supplemented by other components. Other implementations are within the scope of the following exemplary claims.

Therefore, it is intended that the disclosed embodiments and examples be considered as exemplary only, with a true scope of the present disclosure being indicated by the following claims and their equivalents.

What is claimed is:

1. A location system, for locating at least one object within a predefined cell, comprising:
at least first and second receivers (A, B, C, D) and first and second transmitters, respectively, including first and second internal clocks (rxA, rxB, rxC, rxD), said receivers and said transmitters, respectively, having known locations;
a transmitter and a receiver, respectively, worn by said at least one object and designed to communicate by signal exchanges with said receivers and said transmitters, respectively;
electronic circuits designed to compute position related information of said at least one object based on said signal exchanges;
at least two reference transmitters and two reference receivers, respectively, arranged to carry out a calibration operation of said first and second internal clocks (rxA, rxB, rxC, rxD); and
a support adapted to link said at least two reference transmitters and two reference receivers, respectively, to each other, said support being configured such that it may be set at least in a first calibration configuration in which said at least two reference transmitters and two reference receivers, respectively, have a relative distance (dtx1/tx2) with respect to each other which is, a priori, known for the purpose of carrying out the calibration operation.

2. The location system of claim 1, wherein said relative distance (dtx1/tx2) is constant.

3. The location system of claim 1, further comprising at least a third receiver (A, B, C, D) and a third transmitter, respectively, and wherein the location system is arranged to enable a location determination of said at least one object in at least two dimensions.

4. The location system of claim 3, comprising at least four receivers (A, B, C, D) and four transmitters, respectively, to enable a location determination of said at least one object in at least three dimensions, as well as at least a third reference transmitter and a third reference receiver, respectively, having relative distances (dtx1/tx3, dtx2/tx3) with respect to said other two reference transmitters and said other two reference receivers, respectively, which are, a priori, known.

5. The location system of claim 1, wherein said electronic circuits are designed so as to carry out the calibration operation by application of a least squares method or another estimation algorithm.

6. The location system of claim 1, wherein said signal exchanges are carried out in the ultra wide band range.

7. The location system of claim 1, wherein said at least two reference transmitters and two reference receivers, respectively, have relative positions with respect to each other which are, a priori, known.

8. A calibration method for a location system, for locating at least one object within a predefined cell, the location system comprising:
at least first and second receivers (A, B, C, D) and first and second transmitters, respectively, including first and second internal clocks (rxA, rxB, rxC, rxD), said receivers and said transmitters, respectively, having known locations;
a transmitter and a receiver, respectively, worn by said at least one object and designed to communicate by signal exchanges with said receivers and with said transmitters, respectively;
electronic circuits designed to compute position related information of said at least one object based on said signal exchanges; and
at least two reference transmitter and two reference receivers, respectively,
the method comprising the steps of:
arranging said reference transmitters and said reference receivers, respectively, within the cell so that they are linked to each other by a support to have a known predefined relative distance (dtx1/tx2, dtx1/tx3, dtx2/tx3) with respect to each other;
carrying out signal exchanges between said first and second receivers (A, B, C, D) and each of said reference transmitters, between said first and second transmitters and each of said reference receivers, respectively; and
programming said electronic circuits so that they compute the signals as received by said first and second receivers and by said reference receivers, respectively, by use of an analytical computation method, to carry out a calibration of said first and second internal clocks (rxA, rxB, rxC, rxD).

9. The calibration method of claim 8, when the location system is arranged to carry out three dimension location measurements, the latter comprising at least four receivers (A, B, C, D) and at least four transmitters, respectively, each of which comprises an internal clock (rxA, rxB, rxC, rxD), the method further comprising the steps of:
arranging at least a third reference transmitter, at least a third reference receiver respectively, within said cell and at predefined relative distances (dtx1/tx3, dtx2/tx3) with respect to the other two reference transmitters and with respect to the other two reference receivers, respectively;
carrying out signal exchanges between said receivers (A, B, C, D) and each of said reference transmitters, between said transmitters and each of said reference receivers, respectively; and
programming said electronic circuits so that they compute the signals as received by said receivers (A, B, C, D) and by said reference receivers, respectively, by use of an analytical computation method, to carry out a calibration of said internal clocks (rxA, rxB, rxC, rxD).

10. The calibration method of claim 8, wherein computing the signals comprising applying at least one of the following assumptions:
one of said receiver internal clock (rxA, rxB, rxC, rxD) and said transmitter internal clock is considered to be a master clock;
at least two of said reference transmitters and of said reference receivers, respectively, are synchronized; and
at least two of the reference transmitters are located within a given known plane such that they have one coordinate in common, said coordinate possibly being known.

11. The calibration method of claim 8, wherein computing the signals involves times of arrival (TOA) of signals.

12. The calibration method of claim 11, wherein computing the signals further involves angles of arrival of signals and/or strength of arrival of signals.

13. The calibration method of claim 8, wherein said signal exchanges are carried out in the ultra wide band range.

14. The calibration method of claim 8, wherein the relative positions between said reference transmitters are known.

15. The location system of claim 2, further comprising at least a third receiver (A, B, C, D) and a third transmitter, respectively, and wherein the system is arranged to enable a location determination of said at least one object in at least two dimensions.

16. The location system of claim 15, further comprising at least four receivers (A, B, C, D) and four transmitters, respectively, to enable a location determination of said object in at least three dimensions, as well as at least a third reference transmitter and a third reference receiver, respectively, having relative distances (dtx1/tx3, dtx2/tx3) with respect to said other two reference transmitters and said other two reference receivers, respectively, which are, a priori, known.

17. The location system of claim 16, wherein said at least three reference transmitters and three reference receivers, respectively, have relative positions with respect to each other which are, a priori, known.

18. The location system of claim 15, wherein said electronic circuits are designed so as to carry out said calibration operation by application of a least squares method or another estimation algorithm.

19. The location system of claim 15, wherein said signal exchanges are carried out in the ultra wide band range.

20. The location system of claim 15, wherein said at least two reference transmitters and two reference receivers, respectively, have relative positions with respect to each other which are, a priori, known.
